(19) United States
(12) Patent Application Publication
(10) Pub. No.: US 2005/0134119 A1
(43) Pub. Date: Jun. 23, 2005

(54) Time slotting power switching

(76) Inventors: Paul D. Bliley, Vancouver, WA (US); Bill Eaton, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/740,772

(22) Filed: Dec. 18, 2003

(51) Int. Cl. H02J 1/00; H02J 3/00; H02J 3/14

(52) U.S. Cl. 307/40

(57) ABSTRACT

Embodiments of methods, apparatuses and/or systems for time slotting power switching are described.

### BACKGROUND

Electrical and/or electronic circuits operate using a power source. Frequently, although not necessarily, that power source provides direct current (DC) electricity in the form of DC current and/or DC voltage. An associated issue with such power sources is noise reduction. Noise attributable to the power source may in some instances adversely impact overall circuit performance. Thus, it is typically desirable that such noise be reduced. Frequently, noise in such a situation is reduced by employing external filter circuits or the like. Such circuits, however, add complexity and cost.

### BRIEF DESCRIPTION OF DRAWINGS

The claimed subject matter may best be understood by referring to the following detailed description when read with reference to the accompanying drawings in which:

FIG. 1 is a schematic diagram illustrating one embodiment of an integrated circuit chip having the capability to perform an embodiment of time slot power switching;

FIG. 2 is a timing diagram for the embodiment illustrated in FIG. 1;

FIG. 3 is a schematic diagram illustrating an embodiment of a charge pump;

FIG. 4 is a schematic diagram illustrating an embodiment of a DC-DC voltage regulator;

FIG. 5 is a schematic diagram illustrating another embodiment of a DC-DC voltage regulator;

FIG. 6 is a schematic diagram illustrating an embodiment of an H-bridge and DC motor;

FIG. 7 is a portion of another embodiment of a device having the capability to perform an embodiment of time slot power switching;

FIG. 8 is a schematic diagram illustrating an embodiment of a system that includes an embodiment of a power consuming device, such as a computer peripheral.

### DETAILED DESCRIPTION

Embodiments of systems, apparatuses, devices and/or methods for time slotting power switching are described. In the following description, numerous specific details are set forth. However, it is understood that the described embodiments may be practiced without these specific details. In other instances, well-known circuits, structures and/or techniques have not been shown in detail so as not to unnecessarily obscure the provided description.

Reference throughout this specification to “one embodiment” and/or “an embodiment” means that a particular feature, structure, and/or characteristic described may be included in at least one embodiment. Thus, the appearance of the phrases “in one embodiment” or “in an embodiment” in various places throughout this specification typically do not refer to one particular embodiment or the same embodiment. Furthermore, various features, structures, and/or characteristics described through out this specification may be combined in any suitable manner in one or more embodiments.

As previously indicated, electrical and/or electronic circuits operate using a power source. Frequently, although not necessarily, that power source provides direct current (DC) electricity in the form of DC current and/or DC voltage. An associated issue with such power sources is noise reduction. Noise attributable to the power source may in some instances adversely impact overall circuit performance. Thus, it is typically desirable that such noise be reduced. Frequently, noise in such a situation is reduced by employing external filter circuits or the like. Such circuits, however, add complexity and cost. A need, therefore, continues to exist for techniques to reduce power source noise.

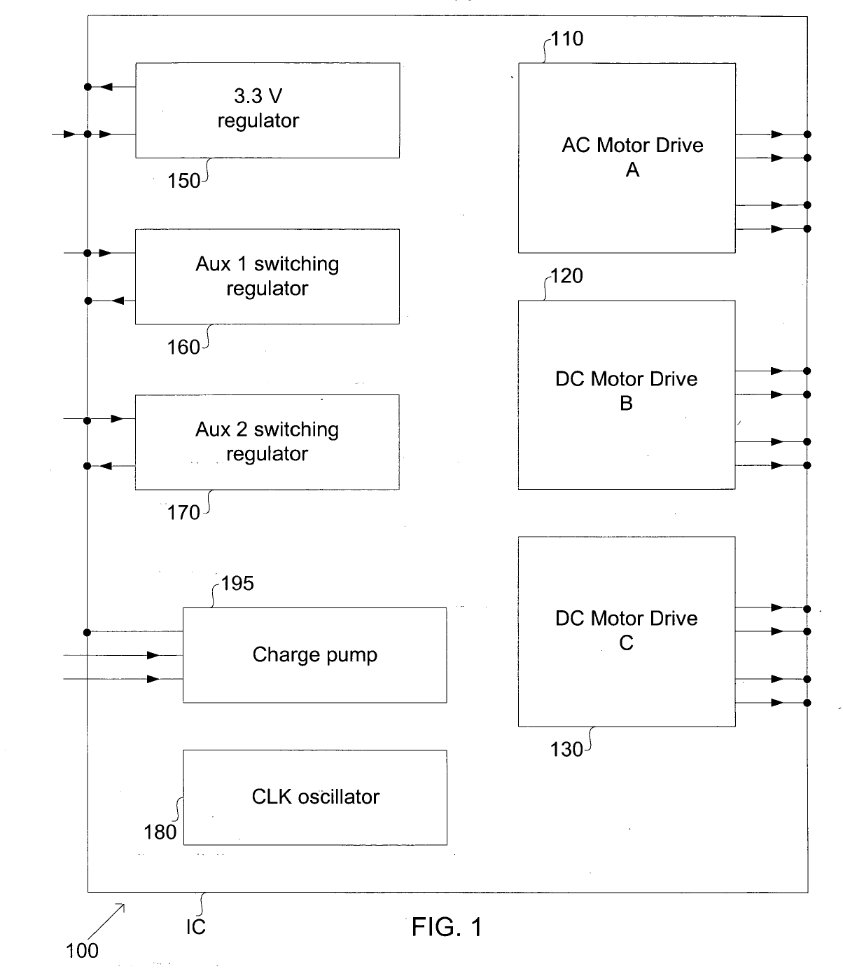

FIG. 1 is a schematic diagram illustrating an embodiment 100 of an integrated circuit (IC) chip, although the claimed subject matter is not limited in scope to this particular embodiment. For example, alternative embodiments are not necessarily embodied in or on one or even more than one IC. This particular embodiment, however, includes an IC that incorporates switching power devices, such as, for this embodiment, switching voltage regulators, such as 150, 160 and 170, and switching motor drive circuits, such as 110, 120 and 130. Embodiment 100 also includes charge pump 175 and clock oscillator 180. In this context, a switching power device refers to a circuit or component of a circuit that regulates and/or modulates power wherein an aspect of that regulation and/or modulation relates to signals that switch or change between distinct electrical levels, such as current levels and/or voltage levels, for example.

Although the claimed subject matter is not limited in scope in this respect, embodiment 100 includes voltage regulators that comprise DC-DC voltage regulators. In this embodiment, for example, 32 volts DC (not shown) is to be applied to IC 100, whereas switching voltage regulator 150 comprises a 3.3 volt switching regulator. Likewise, in this particular embodiment, auxiliary regulators 160 and 170 also comprise DC-DC voltage regulators, although other regulators may alternatively be employed, such as AC-DC or AC-AC regulators, for example, depending on the particular application involved. In this embodiment, regulators 160 and 170 may be employed to produce a higher or lower output voltage level other than 3.3 volts DC, if desired. It is noted, therefore, that these voltage values are merely examples and are not intended in any way to limit the scope of the claimed subject matter. Thus, switching voltage regulators may provide any desired voltage level or a plurality of voltage levels. Likewise, a host of potential architectures are available for switching regulators, including, without limitation, buck converters, regulators that employ feedback, push-pull voltage regulators, and the like.

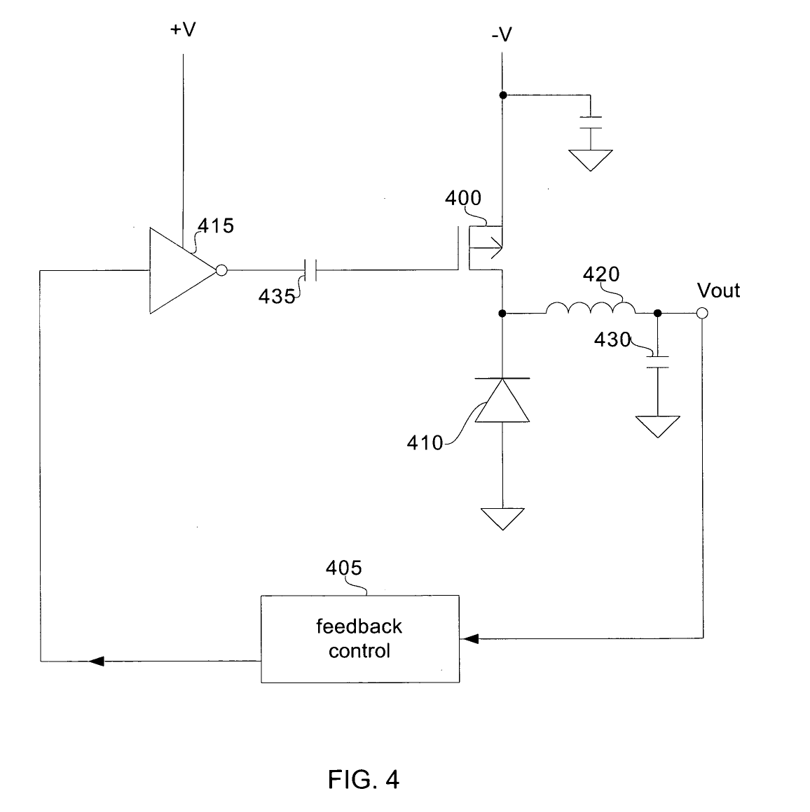

A typical switching voltage regulator configuration is illustrated in FIG. 4, although, of course, this is simply one example. In the embodiment shown in FIG. 4, one field effect transistor (FET) is employed. This embodiment includes a high-side FET, 400, and a low-side diode, 410, although a variety of other embodiments may alternatively be employed. For example, 410 might instead comprise another FET. Here, 400 comprises a P-channel FET. As illustrated, FET 400 provides a signal path to inductor 420. Although not illustrated in detail, the filtered voltage output signal is provided by inductor 420 and capacitance 430 to feedback control circuitry 405 in FIG. 4. This particular feedback control circuitry provides a feedback signal to FET driver 415. Thus, based at least in part on the output voltage signal level, the feedback control circuitry operates to adjust the output voltage signal level produced by driving the input port of the FET. Of course, the feedback signal could be directly coupled to the FET alternatively. Here, however, in this embodiment, capacitor 435 is interposed to filter out DC bias from the signal applied to the FET. As previously discussed, this is merely one potential embodiment out of a myriad of potential circuits that may be employed.

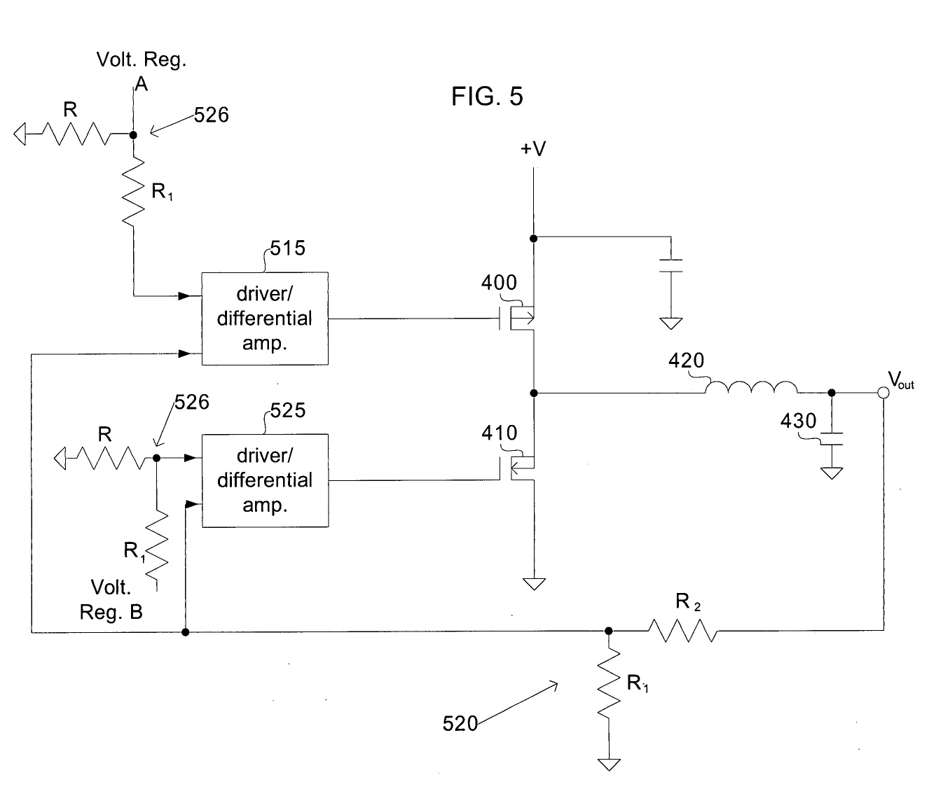

IC 100 includes two auxiliary voltage regulators 160 and 170. The output voltage of these switching voltage regulators may be set based, at least in part, upon the application of an external signal. For this embodiment, although, of course, the claimed subject matter is not limited in scope in this respect, these regulators may be set to a voltage level from 1 volt to 16 volts. This may be implemented any one of a number of ways and the claimed subject matter is not limited to a particular approach; however, FIG. 5 illustrates one potential technique. For the auxiliary regulators, for example, feedback control may be accomplished with a voltage divider 520. A similar configuration 526 may also be applied to the reference signals except that R may be an externally provided resistance, for example, so that the output voltage signal may be effectively adjusted. Thus, for the embodiment shown in FIG. 5, the feedback signal is applied to drivers/differential amplifiers 515 and 525 and compared with reference signals A and B. Adjusting R adjusts the reference signals, which adjusts the output voltage signal. Likewise, as previously described, any one of a number of switching voltage regulators may be employed for 160 and 170 and the claimed subject matter is not limited in scope to a particular type of switching voltage regulator.

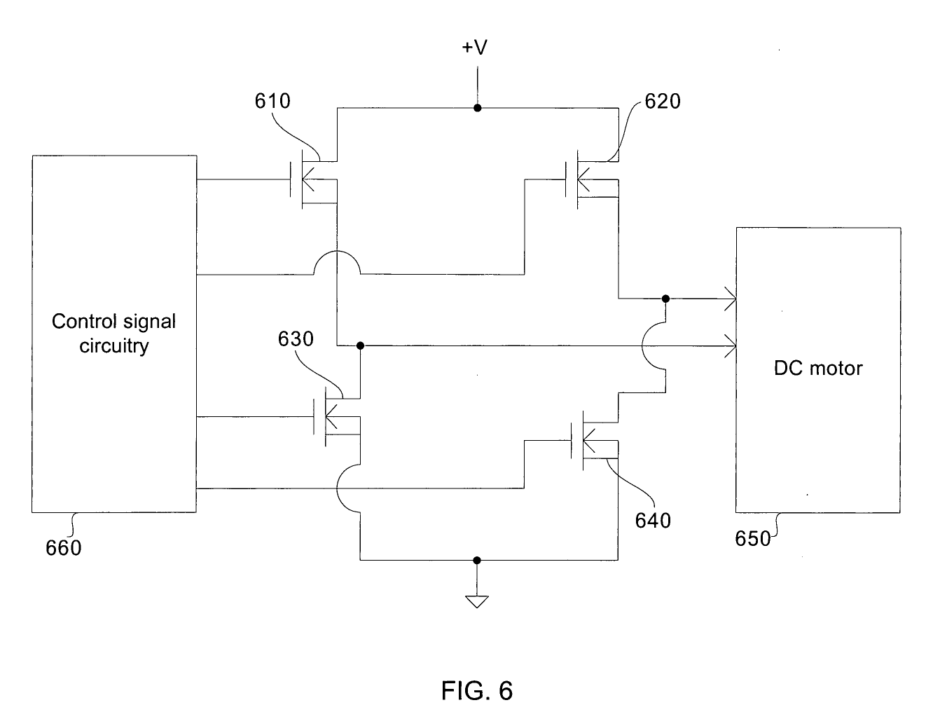

As suggested above, in addition to switching power regulators, IC 100 includes switching power motor drive circuits or circuitry, such as 110, 120 and 130. These circuits may provide power signals to drive a motor external to the IC. Although the claimed subject matter is not limited in scope in this respect, these motor drive circuits may include an H-bridge circuit. In this context, an H-bridge circuit refers to a circuit having an H configuration, as shown in FIG. 6, for example, where the switching elements of the circuit may apply current to a DC motor that adjusts the duty cycle of the motor by adjusting the duty cycle of the applied current.

Referring to FIG. 6, a DC motor 650 is electrically coupled in the form of an H-bridge circuit that includes four switching elements, 610, 620, 630 and 640, here FETs. Control signal circuitry 660 applies voltage signals to the gates of the FETs to switch the states of the switching elements. These elements may be employed to control or adjust the rotation speed of the DC motor, by adjusting the duty cycle of a pulse current applied to the motor, and to reverse the direction of rotation by changing the direction of the applied current. Switching elements 610 and 620 are coupled to a power supply V, while elements 630 and 640 are coupled to ground. The motor has one terminal coupled to the junction between 610 and 630 and the other coupled to the junction between 620 and 640. By combining the switching operation of 610-640, speed control, including reversing, may be realized by adjusting the current applied to the DC motor. For example, when elements 610 and 640 are off, current flows from the power source to ground via 620 and 630. This results in the motor rotating in a forward direction. Likewise, if 610 and 640 are on while 620 and 630 are off, this results in reverse current flow and, consequently, the motor rotating in a reverse direction.

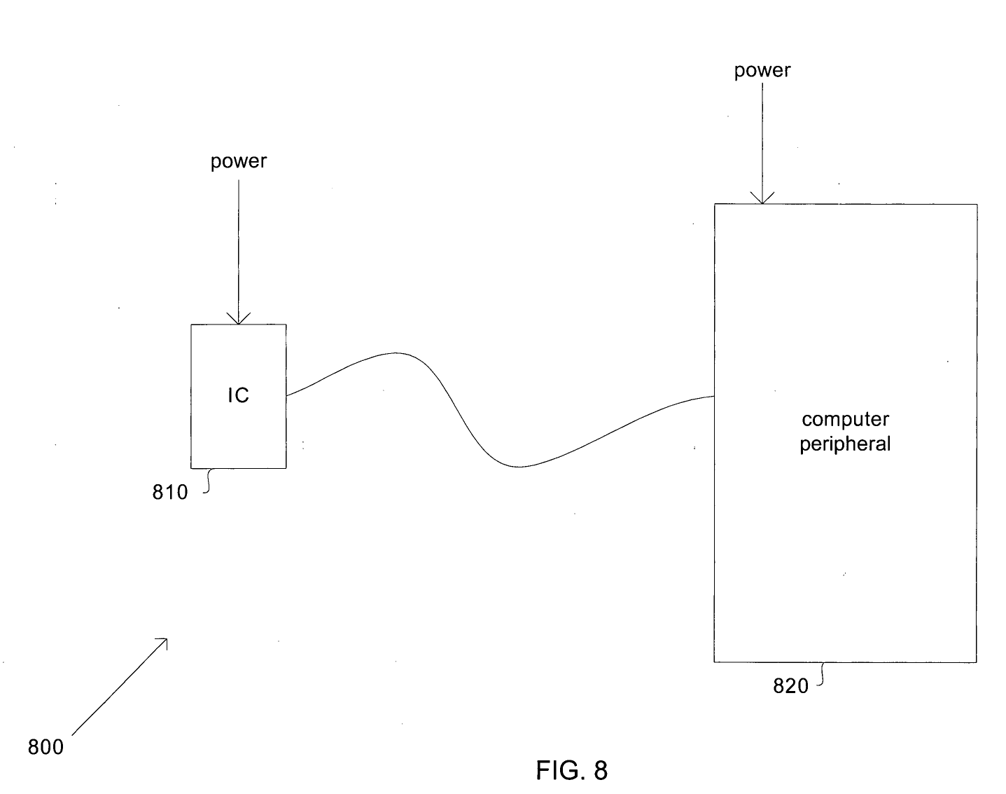

FIG. 8 illustrates an embodiment 800 of a system that may include an IC 810 including a switching voltage regulator and/or a switching motor drive circuit, as previously described, for example, coupled to a power consuming device 820, such as a computer peripheral, for example. Although the claimed subject matter is not limited in scope in this respect, motors, for example, may be employed in any one of a number of potential external devices, including, for example, a computer peripheral device, such as a printer, scanner, copier, a facsimile machine and/or any combination thereof, for example. Other devices may include digital cameras, such as digital still or digital video cameras, cell phones, personal digital assistants, televisions, radios, DVD players, CD players, cassette players, hard drives, DVD burners, CD burners, floppy drives, electronic game devices, etc. Thus, in general, any device that employs a motor and/or any device that consumes power may employ either a driver circuit or a regulator circuit, as previously described.

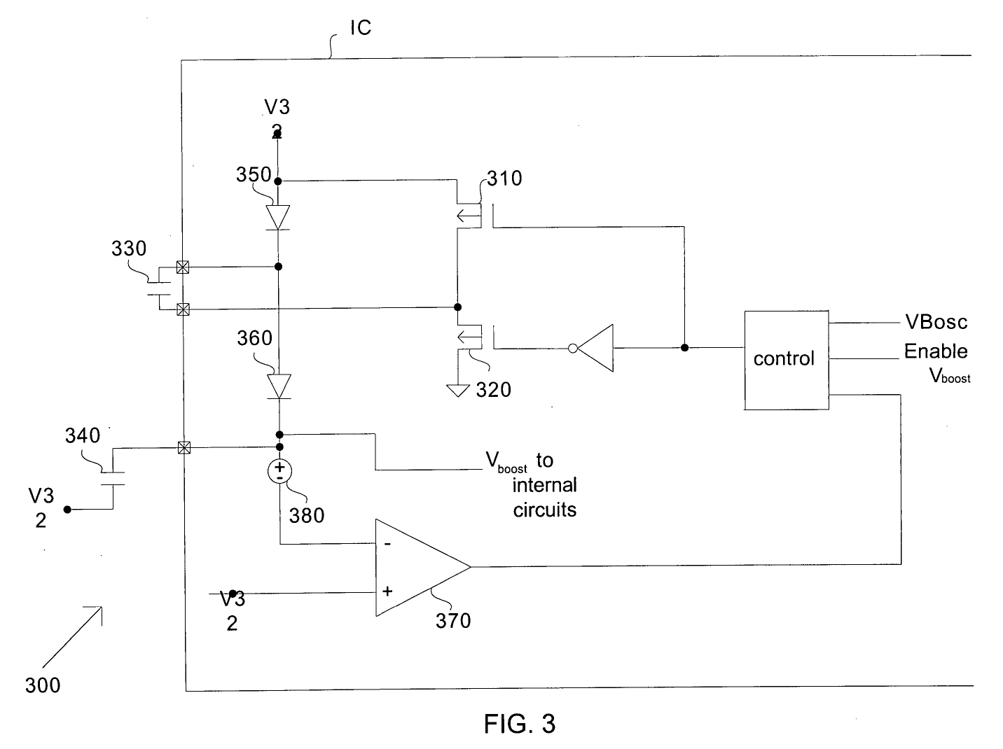

Likewise, IC 100 also includes a charge pump, although, again, the claimed subject matter is not limit in scope to including a charge pump. FIG. 3 illustrates one potential embodiment of a charge pump. Here, the charge pump is employed to provide a voltage source greater than 32 V to assist in turning on NMOS devices that may be located elsewhere on the IC. This is, of course, just one possible application of a charge pump and the claimed subject matter is not limited in scope to this particular application. However, as illustrated in FIG. 3, this embodiment operates by switching transistors, or here, FETs, 310 and 320 so that charge is first accumulated on capacitor 330 followed by dumping that charge from capacitor 330 to capacitor 340. Thus, FET 320 is turned on first. Current flows from voltage source V32 through diode 350 through capacitor 330 and through FET 320. Thus, capacitor 330 is charged to 32 volts. After capacitor 330 is charged, FET 320 switches off and FET 310 switches on. Current then flows from voltage source V32 through FET 310 through capacitor 330 and through diode 360 into capacitor 340. Thus, capacitor 340 is charged to above 32 volts. Comparator 370 and internal voltage source 380 are used to determine how far above 32 volts to charge capacitor 340.

As previously described, FIG. 1 and the previously described circuitry are merely example embodiments and the claimed subject matter is not limited in scope in any way to employing the previously described circuitry. Thus, other circuitry may be employed instead of or in addition to that previously described. Thus, the claimed subject matter is not limited in scope to the particular type of switching power devices illustrated in FIG. 1. For example, other types of switching power devices include circuits to drive compressors, such as for a refrigerator or air conditioner, circuits to drive lighting, such as lamps or other lighting apparatuses, circuits to drive displays, circuits to drive appliances, such as blenders, toasters, mixers, and the like, circuits to drive electronic toys, circuits to drive televisions, stereos, DVD players and CD players, and/or any other type of switching power driver circuit now known or later developed. Again, any device that consumes power may include a switching driver or regulator circuit and, thus, is included within the scope of the claimed subject matter.

As described in more detail hereinafter, an aspect of the previously described embodiment includes time slotting the switching of such switching power devices. In this context, the term time slotting refers to arranging for switching of two or more switching power devices so that at least two, or all, switching power devices are not substantially coincident regarding the timing of their respective switching. Here, the term is used with reference to a base frequency of oscillation where time slots refer to particular periods or sub-periods of a string of periods. In some embodiments, this may refer to switching the devices “on,” frequently indicated by the rising edge of a timing pulse derived from said periods, sub-periods, or string of periods, whereas in other embodiments this may refer to all switching of the switching power devices, meaning in such embodiments that all switching of the particular devices at issue is intended to be substantially non-coincident.

One advantage of this particular approach is that the amount of power drawn from the power source may be spread out over time, which has potentially beneficial effects. For example, switching noise that might be induced by changes in current may be reduced. This may be due, at least in part, to a reduction in the change in current that would otherwise occur when a particular device is switched on or off. More particularly, if two such devices that otherwise might switch on at the same, or substantially the same, pulse no longer do so, the change in current, and potentially the induced noise, may be reduced. Although the claimed subject matter is not limited in scope to an IC, for embodiments implemented on an IC, the size and proximity of the circuitry may make reducing such noise desirable since it may be more likely to detrimentally impact overall circuit performance. Likewise, another potential benefit may be reduced EMI emissions; however, it will be appreciated that the claimed subject matter is not limited to embodiments demonstrating reduced switching noise or reduced EMI emissions. These are simply examples of potential benefits of time slotting power device switching. Time slotting provides additional benefits and, thus, the claimed subject matter is not limited in scope to embodiments that provide a particular enumerated benefit.

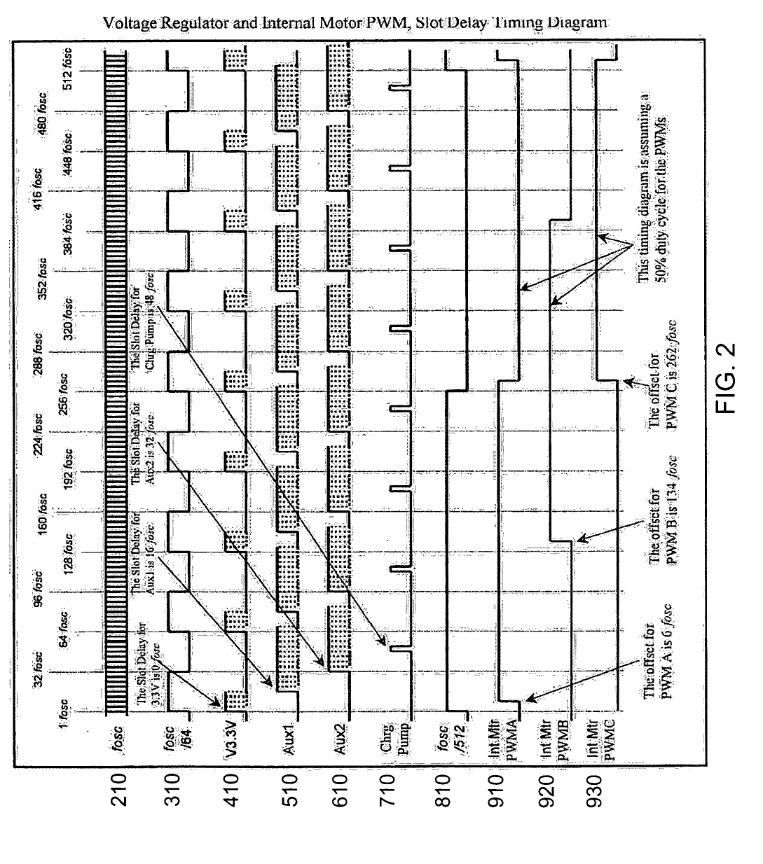

FIG. 2 is a timing diagram for the embodiment shown in FIG. 1. Waveform 210 illustrates the base frequency of oscillation for this particular embodiment. Of course, the claimed subject matter is not limited in scope to a particular frequency of oscillation. Likewise, waveform 310 illustrates a typical square wave. As illustrated, 64 oscillations of the base frequency take place within one period of square wave 310, although, again, this is merely an example and does not limit the scope of the claimed subject matter. Square wave 310 is provided merely as a basis for comparison of the time slotting that is applied in this particular embodiment. Thus, as illustrated, waveform 410 indicates the switching of switching voltage regulator 150. Here, this occurs substantially coincident with the rising edges of square wave 310. Voltage regulators 160 and 170, by contrast, switch relative to square wave 310, but after its rising edge, indicated by waveforms 510 and 610, respectively. As indicated in FIG. 2, switching regulator 160 switches on or nearly on the 16^{th} pulse of the base frequency, whereas switching regulator 170 switches on or nearly on the 32^{nd} pulse of the base frequency. Thus, here, the switching of the switching voltage regulators is not substantially coincident, as desired. It is, of course, appreciated that the claimed subject matter is not limited in scope to switching on a particular pulse of an oscillating base frequency and these are merely provided as examples. Furthermore, in this embodiment, all of the switching regulators are time slotted so that none substantially coincide in switching. Of course, depending on the particular embodiment, it may be acceptable for some subset of the switching voltage regulators, or other switching power devices, to be time slotted so that their switching substantially coincides, while others do not substantially coincide.

Waveform 810 illustrates another square wave, again merely for purposes of comparison. This particular waveform includes 512 oscillations or periods of the base frequency within its period. It is likewise noted that a square wave, such as 810, represents a 50% duty cycle, although, of course, the claimed subject matter is not limited in scope to a 50% duty cycle. Any duty cycle of any percentage is included within the scope of the claimed subject matter. For this particular embodiment, however, the motors being driven employ at least approximately a 50% duty cycle. As previously described, the duty cycle of the applied waveform will affect the duty cycle of the motor. As illustrated, however, by waveforms 910, 920 and 930, these waveforms are time slotted so as not to switch substantially coincidentally. Thus, referring to 910, the rising edge occurs on or nearly on the 6^{th} pulse of the base frequency, whereas for 920 the rising edge is on or nearly on the 134^{th} pulse, and 930 switches on or nearly on the 262^{nd} pulse. In this particular embodiment, as above for the switching voltage regulators, none of the switching performed by the drive circuitry for the motors is substantially coincident, although, again, in an alternative embodiment, it may be acceptable for some switching to be substantially coincident.

Another aspect of this particular embodiment, although, again, the claimed subject matter is not limited in scope in this respect, is that none of the switching by any of the switching power devices is substantially coincident. For example, as illustrated by waveform 710, charge pump 140 switches at about the 48^{th} pulse of the base frequency. Again, in some embodiments, it may be acceptable for some of the switching by the switching power devices to be substantially coincident. This may vary with a host of factors, such as the size of the circuitry, the source of the power, the proximity of the switching devices, and the amount of current drawn during turn on of the particular devices, although, these are just a sample of the potential factors that may influence whether or not some amount substantially coincident switching may be acceptable.

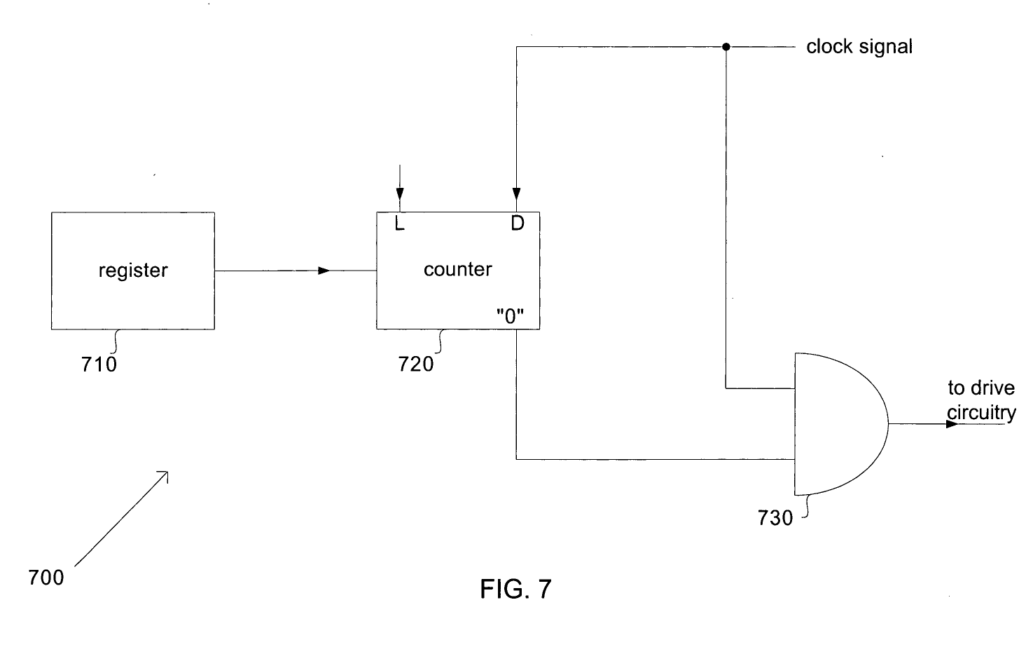

It is likewise noted that another embodiment may include the capability to program the particular time slot for switching of one or more of the switching power devices. For example, in an IC embodiment, although, again, the claimed subject matter is not limited in scope to an IC embodiment, registers may be included so that switching may be time slotted by the number of elapsed oscillations of the base frequency. Referring to FIG. 7, for example, the contents of register 710 may be loaded into counter 720 by applying a signal to the L port of the counter. Counter 720 may then be decremented on each successive clock pulse by applying the clock signal to port D. Counter 720 counts down to zero at which point an output signal is applied to AND gate 730 along with the clock signal. Since the output signal of the counter is now “high,” the clock signal passes through AND gate 730 to the drive circuitry to initiate the appropriate circuit on the appropriate pulse of the clock. Of course, this is just one example of a technique to program the time slotting of switching power devices and the claimed subject matter is not limited in scope to this particular example. Many other techniques are possible and included within the scope of the claimed subject matter, including other hardware circuits, programming in firmware, or in software stored in random access memory, on a CD, on a floppy disk, or on some other storage media, or programming using any combination of hardware, firmware, and/or software.

While the claimed subject matter has been described in terms of several embodiments, those of ordinary skill in the art will recognize that the claimed subject matter is not limited to the embodiments described, but may be practiced with modifications and/or alterations to those embodiments and remain within the spirit and/or scope of the appended claims. The description is thus to be regarded as simply illustrative and is intended in no way to limit the scope of the claimed subject matter.

1. A method comprising:
time slotting power switching.

2. The method of claim 1,
wherein said time slotting power switching includes time slotting at least one switching voltage regulator.

3. The method of claim 2, wherein time slotting at least one switching voltage regulator comprises time slotting at least one DC-DC switching voltage regulator.

4. The method of claim 3, wherein said at least one DC-DC switching voltage regulator comprises more than one DC-DC switching voltage regulator.

5. The method of claim 1, wherein said time slotting power switching includes time slotting at least one switching motor drive circuit.

6. The method of claim 5, wherein said at least one switching motor drive circuit includes a duty cycle.

7. The method of claim 6, wherein said duty cycle comprises at least approximately a 50% duty cycle.

8. The method of claim 1, wherein said time slotting power switching includes time slotting at least one charge pump.

9. The method of claim 8, wherein said time slotting power switching also includes time slotting at least one switching voltage regulator and at least one switching motor drive circuit, and wherein said at least one switching voltage regulator, said at least one switching motor drive circuit, and said at least one charge pump are slotted for times that do not substantially coincide.

10. The method of claim 1, wherein said time slotting power switching includes time slotting at least one switching voltage regulator and at least one switching motor drive circuit, and wherein said at least one switching voltage regulator and said at least one switching motor drive circuit are slotted for times that do not substantially coincide.

11. The method of claim 10, wherein said at least one switching voltage regulator comprises more than one switching voltage regulator and said at least one switching motor drive circuit comprises more than one switching motor drive circuit, wherein said more than one switching power regulator and said more than one switching motor drive circuit are all slotted for times that do not substantially coincide.

12. A method comprising:
time slotting power switching devices so that switching of at least some of said switching power devices does not substantially coincide.

13. The method of claim 12, wherein time slotting switching power devices further includes time slotting switching power devices so that rising edges of pulses of at least some of said switching power devices do not substantially coincide.

14. The method of claim 12, wherein said switching power devices comprise switching motor drive circuits.

15. The method of claim 12, wherein said switching power devices comprise switching voltage regulators.

16. An apparatus comprising:
an integrated circuit chip (IC), said IC including a plurality of switching power devices, said IC adapted to time slot said switching power devices so that switching of at least some of said plurality of switching power devices does not substantially coincide.

17. The apparatus of claim 16, and further comprising: a plurality of power consuming devices coupled to said IC.

18. The apparatus of claim 16, wherein a particular time slot of at least one of said switching power devices is programmable.

19. The apparatus of claim 18, wherein said particular time slot is programmable via circuitry included in said integrated circuit chip.

20. The apparatus of claim 18, wherein said particular time slot is programmable via software stored on a storage medium.

21. A system comprising:
an integrated circuit chip (IC), said IC including a plurality of switching power devices, said IC adapted to time slot switching so that switching of at least some of said plurality of power switching devices does not substantially coincide;
said integrated circuit chip coupled to at least one power consuming device.

22. The system of claim 21, wherein said at least one power consuming device comprises at least one of a printer, a scanner, a facsimile and a copier.

23. The system of claim 21, wherein a particular time slot of at least one of said switching power devices is programmable.

24. The system of claim 23, wherein said particular time slot is programmable via a register to program said particular time slot.

25. An apparatus comprising:
an integrated circuit chip (IC);
said IC including means for time slotting switching power devices so that switching of at least some of a plurality of switching power devices does not substantially coincide.

26. The apparatus of claim 25, and further comprising: a plurality of power consuming devices coupled to said IC.

27. The apparatus of claim 25, wherein a particular time slot of at least one of said switching power devices is programmable.

28. The apparatus of claim 27, wherein said particular time slot is programmable via circuitry included in said integrated circuit chip.

29. An apparatus comprising:
means for time slotting switching power devices so that switching of at least some of a plurality of switching power devices does not substantially coincide; and
at least one power consuming device.

30. The apparatus of claim 29, and further comprising: at least another power consuming device.

31. The apparatus of claim 31, wherein said at least one power consuming device comprises a computer peripheral.

32. The apparatus of claim 29, wherein said means for time slotting power devices is programmable.
